(19) United States
(12) Patent Application Publication
(10) Pub. No.: US 2010/0305966 A1
(43) Pub. Date: Dec. 2, 2010

(54) Robotic Management of Patient Care Logistics

(75) Inventors: Robert Craig Coulter, Apollo, PA (US); Ralph Gross, Pittsburgh, PA (US); Jean-Francois Lalonde, Pittsburgh, PA (US); Barbara Anne-Marie Simard, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: DISRUPTIVE IP, INC., Apollo, PA (US)

(21) Appl. No.: 12/791,208

(22) Filed: Jun. 1, 2010

Related U.S. Application Data
(60) Provisional application No. 61/182,356, filed on May 29, 2009.

(51) Int. Cl. G06Q 50/00

(52) U.S. Cl. 705/2

(57) ABSTRACT

In a method and system of controlling patient care logistics, a computer determines for each of a number of user devices a unique priority sorted list of queue tasks on the basis of global criterion. Each user device is dispatched the unique priority sorted list of queue tasks determined for the user device. In response to receiving a change in at least one global criterion, the computer determines for each user device either an amendment to the unique priority sorted list of queue tasks for the user of the user device or a new unique priority sorted list of queue tasks for the user of the user device, and then dispatches the unique priority sorted list of queue to the user device.

### CROSS-REFERENCE TO RELATED APPLICATION

This application claims priority from U.S. Provisional Patent Application No. 61/182,356, filed May 29, 2009, which is incorporated herein by reference.

### BACKGROUND OF THE INVENTION

1. Field of the Invention

The present invention relates to a system and method of logistics management in a clinical environment.

2. Description of Related Art

Nurses currently spend the vast majority of their time managing the logistics of providing direct patient care and the minority of their time actually performing clinical procedures. Logistics, in this sense, means coordinating the physical movement of patients, charts, medications, lab samples, and other healthcare “objects” through the physical structure of a hospital in order to bring the right caregivers, patients, and treatment objects into the same physical space such that a treatment can be administered—a process herein called Care Logistics Management (CLM). In order to do so, caregivers must collect, analyze and review significant quantities of both logistical and clinical information—some of which is contained in databases and some of which can only be accessed by communicating directly with one or more other caregivers who have needed knowledge.

Clinical decisions drive logistical decisions and both decision types must often be made in collaboration with a group of caregivers. All of these logistical steps require significant amounts of nursing time as caregivers must: (i) go to computers in order to access patient clinical information (or determine whether such information is even available); (ii) find other caregivers in order to first collaborate on making clinical decisions and then determine logistically how that will impact the movement of the patient and care resources through the hospital; and (iii) collaborate with still further caregivers in order to execute the logistical plan. Multiply these basic steps across hundreds of nurses and patients and it becomes rapidly clear that addressing the inefficiencies of communicating among caregivers represents an enormous opportunity to reduce the cost of healthcare.

A further review of nursing practices indicates that, among the many logistical decision tasks that nurses perform, a great many can be automated, bringing further efficiencies to the healthcare system. Moreover, logistical decisions are currently only made with a local awareness, i.e. a nurse decides which patient to treat next based only on the patients she sees on her floor, because she lacks any information that indicates how her logistical decision (e.g. treat patient A before discharging patient B) impacts other units of the hospital (e.g. if she discharges patient B first, that could free a bed to accept an admission from an overflowing Emergency Department).

At this very moment, it is likely that tens of thousands of people are sitting in the waiting rooms of thousands of healthcare facilities (hospital ER's, cancer clinics, dialysis clinics, physical therapy hospitals, etc.) all around the globe. “Waiting for healthcare” is the most visible sign of an unaddressed limitation of the global healthcare system—the management of the logistics of direct patient care.

The global healthcare system excels at understanding disease processes and developing disease treatments. However, the logistics of cost-effectively scaling the delivery of a treatment remains an almost entirely manual process that must be managed and coordinated by each facility's nursing staff. A 2008 study found that the vast majority of a nurse's time is spent managing logistics, (i.e. performing documentation, making phone calls, managing databases, and managing medications in order to move patients through progressive stages of care) compared with 20% spent delivering direct patient care. Problems with patient logistics present a clear opportunity to effect an enormous improvement in healthcare cost and quality: employ technology to offload the clinical staff from the burdens of managing the logistics of direct patient care.

The cost of managing patient care logistics is an unnecessary burden on the global healthcare system, as it saddles highly skilled nurses and nursing managers with logistics management problems that distract from clinical care. Moreover, human beings are generally not skilled in performing complex, distributed planning and scheduling functions in real-time—there is simply too much data and too many possible plans to consider, especially when plans must be altered in real-time to accommodate changes in patient census and acuity. And finally, this problem has very important human consequences. Waiting for healthcare is a form of human suffering—one which will eventually affect each of us.

The modem patient experience with healthcare is perhaps best defined as the Uncertain Wait. The waiting room is a place full of anxiety for most patients. They know that they will have to wait to receive care, they are uncertain of when that care will come, and they generally have little or no means of questioning the hospital's logistics system other than asking a nurse how long they think it will be before someone sees them. The nurse probably doesn't know either, because she lacks the information necessary to accurately predict when that particular patient will be treated. Importantly, the uncertainty over waiting is systemic. It is not the case that the hospital staff knows when each patient will be seen and simply isn't sharing that information—no one knows. The nursing staff can only tell patients the order in which they will be seen (e.g. the patients with the most critical care needs will be seen first . . . ) but they have no way of predicting when that will be.

Patients experience the Uncertain Wait at each state of their treatment. For example, a patient entering an Emergency Department (ED) has an uncertain wait for triage, then for an emergency department bed, for an X-ray in radiology, for blood work, to see a physician, and so forth. Should they be admitted, they have an uncertain wait before being transferred to a bed in another unit. In some sense, the waiting room experience is replicated throughout the entirety of a patient's treatment experience because at every stage of care, healthcare facilities collect and pool patients, then treat them one at a time according to priority criteria that remain a mystery to the patients themselves.

The impact of pooling and prioritizing patients at each stage of treatment extends far beyond the patient and into the community at large. Uncertain Wait times impact all of those who are direct or indirect participants in patient care. The patient's family members who transport and pickup their loved ones, or those who provide care for the patient's minor children or aged parents are directly impacted by the efficiency of the hospital's logistics system. Adult care supporters often have to take time off from work, place their own children in daycare or find babysitters, or otherwise make changes to their schedules in order to support the patient's treatment. Uncertainty in the patient's care therefore ripples into the schedules of their families, employers, and other caregivers in the larger community.

Patients families are naturally eager to understand what is happening with their loved ones. Certain information about the progress of medical treatment is only appropriate to be communicated by medical professionals—for example, the results of surgery or the effectiveness of cancer treatment should clearly be communicated by doctors and nurses prepared to provide detailed medical information, opinions, and psychological support to families However, these same healthcare professionals are often the only avenues open to patients and their families who have questions about the logistics of their care—many of which could be securely delivered electronically, to locations both within and outside of the healthcare facility, with potentially greater satisfaction to patients and their families

The logistics of providing patient care is critically tied to the perception of the quality of the healthcare organization. Patients, patient families, and physicians all form opinions of “how organized” the healthcare facility is based upon how efficiently patients are “taken care of.” This perception naturally carries over to the perceived quality of the facility's clinical care; for, one reasons, if a facility can't efficiently move patients around, how can they possibly be expected to perform critical procedures such as surgeries. Patient and physician satisfaction with Care Logistics impacts the reputation of a healthcare facility, which in turn drives physician placements and patient self-selection, etc.

It is important to realize that every stakeholder in the healthcare system, patients, physicians, nurses, healthcare administrators, and insurance providers all want to eliminate patient wait time for two reasons. First, all parties share the humanitarian desire to provide patients with timely access to medical care. Everyone, after all, is the patient at some point in time. Second, all parties recognize that patients waiting for healthcare is simply a symptom of a more general problem: inefficiencies within the patient logistics process. This root problem manifests itself as an economic problem (the cost of healthcare), a capacity problem (the maximum number of patients that a hospital can see, given the size of its nursing staff), and a healthcare quality problem (overloaded nurses are more likely to make medical errors, and less likely to complete patient charting in sufficient detail).

Care Logistics Management:

Care logistics are the logistics associated with providing patient care. Logistics, in this sense, means coordinating the physical movement of patients, charts, medications, lab samples, and other healthcare “objects” through the physical structure of a hospital or other clinical setting in order to bring the right caregivers, patients, and treatment objects into the same physical space at the right time such that a treatment can be administered. Care logistics is generally performed by groups of caregivers who: (i) make decisions about what logistics are required by each patient, and (ii) manage staff to carry out those logistics functions. The logistics decisions-making and management processes are termed Care Logistics Management (CLM).

The efficiencies of the Care Logistics Management (CLM) process fundamentally defines the efficiencies with which treatments scale to patient populations, precisely because it defines the cost of providing that treatment to patients in quantity. To use a manufacturing analogy, CLM is the healthcare industry's equivalent to manufacturing management. It is the practice of bringing together all of the components of treatment: the patient, healthcare providers, medications, equipment, and information, that are required in order to deliver that treatment.

CLM in modern healthcare is (i) overwhelmingly manual and (ii) inefficiently performed on an ad-hoc basis by groups of nurses at a local level. The practice of CLM functions by the nursing staff may consume up to 80% of their time, leaving little time for clinical practices such as treatment delivery.

One logistical model of a general healthcare facility can be envisioned as follows:
Organization by Units—All healthcare facilities are divided into specialized care units.
Unit to Unit Patient Flow—Patients may move from any unit to any other unit; however, there are certain preferred paths that patients generally or usually follow. For example, it is often the case that Emergency Department patients transfer to an Intensive Care Unit (ICU). It is rarely the case that a Labor and Delivery patient transfers to an Orthopedic Unit.
Unit Based Resources—Each unit has unit-specific care resources (e.g. nurses, nurse managers, etc.) who provide care to the patients. These resources are usually responsible for multiple patients and perform a variety of both clinical and logistical tasks.
Care Support Resources—Other care resources either (i) come to the unit to provide additional care to the patients or (ii) work remotely, but send either information or supplies necessary to provide care to the patients. Physicians, therapists (e.g. respiratory therapist), transportation assistants, dietary assistants, and pharmacists are all examples of care support resources.
Scheduling Care Resources—All care resources must be scheduled to provide for the needs of all patients. Different patients have different needs and each patient requires a potentially unique blend of care resources to provide for their treatment.
Healthcare Facilities are Organized by Units

Specialized Clinical Care Units:

All healthcare facilities, whether in-patient or out-patient may be segmented into a set of specialized care units. These units each focus on providing a specific type of clinical care to patients of specific acuity, e.g. the emergency department, medical/surgical units, critical care units, cardiac care units, labor and delivery, maternity, respiratory, anesthesiology, and so forth.

In-Patient Units:

Emergency departments, medical/surgical units, labor and delivery, and other similar units are organized around patient beds and function as the primary clinical care units. These units house in-patients throughout their hospitalization.

Out-Patient Units:

Cancer centers, dialysis centers, radiology units or centers, outpatient surgeries, physicians offices, dental offices, and other such facilities are organized around treatment spaces. Patients are not housed at these facilities and, as such, are expected to spend much less time at the facility than in-patients.

Care Support Units:

Other departments, such as laboratory services, dietary services, and respiratory services visit patients in their rooms to, for example, take blood samples, deliver food, or provide a specialized treatment. Still other units, such as medical records and pharmacy, will never directly interact with the patients themselves but send either data (charts) or supplies (medications) to the patients' caregivers in support of patient treatments.

Resources Labeled by Function within a Specific Facility:

Note that resources that are labeled care units in one treatment facility (e.g. laboratory services in the out-patient example) may be care support in another treatment facility (e.g. laboratory technicians visiting the in-care patient to draw blood). In certain scenarios a resource may function as both a unit and a care support service, e.g. radiology is a Unit, but also sends portable X-Ray equipment and technicians to patient rooms when moving those patients is problematic, such as in ICU.

Unit-to-Unit Patient Flow:

In-Patient Flow:

In-patients may progress from unit-to-unit as their clinical care needs change sufficiently to require the resources of a different unit. The patients' caregivers (often collaboratively) arrive at the clinical decision that it is time to move the patient from one unit to another. As one example, a patient may present to the Emergency Department (ED) with a heart attack, be stabilized and then transferred to a cardiac care unit for a few days, then as his condition improves be transferred again to a step-down unit (e.g. with less highly specialized equipment) for another few days before finally being discharged. Each Unit transfer is based upon a change in the patient's clinical condition (e.g. stabilization, followed by improvement) that require units with different (e.g. in this case lesser) care capabilities. Desirably, the patient is only transferred after completing all treatments on a treatment checklist for the current unit, unless medical necessity compels otherwise.

Out-Patient Flow:

Outpatients generally do not experience significant changes in acuity. Their movement from unit-to-unit is generally driven by a series of different clinical procedures, each of which is performed in a different unit. For example, an out-patient presenting at a cancer clinic may progress from an out-patient phlebotomy lab to a physician's office to a chemotherapy treatment space. The transition to the next unit is based primarily on the satisfactory completion of treatments on a treatment checklist for the current unit, unless medical necessity compels otherwise.

Care Support driven by Treatment Plans:

In both in-patient and out-patient scenarios, care support units (e.g. dietary, pharmacy, medical records, etc.) may be called upon to collaborate in the treatment of the patient. Care support is generally scheduled by the units charged with providing the patient's primary care, as per the needs of the patient's treatment plan.

Care support providers will generally collaborate with care providers in the patient's primary care unit in order to decide upon the clinically appropriate care support treatment, service, medication, etc. For example, the pharmacy may need to discuss the potential for a drug interaction (e.g. between two different medications prescribed by two different physicians) with the patient's nurse before fulfilling the order. As another example, the medical records department will coordinate behind the scenes to, e.g. provide all relevant medical information to all care givers along a patient's path.

Temporary Patient Transfers:

Throughout a patient's care, he or she may need to be temporarily transferred to certain specialized units, such as radiology, surgery, physical therapy, and so forth. These temporary transfers may not require the same degree of transfer collaboration between nurses as normal unit-to-unit transfers, as the patient is not formally discharged from a care unit. While temporarily in the temporary unit, the patient's primary caregivers may be required to collaborate with caregivers in the temporary unit and potentially with other caregivers, in order to effect the treatment in the temporary unit.

Scheduling Patient Care:

The Role of Scheduling in CLM:

The primary CLM function is to schedule the appropriate resources necessary to provide care to each and every patient. Nurses and/or non-clinical scheduling assistants determine when to schedule patients (either in-patient or out-patient) for treatments, diagnostics, physician visits and so-forth.

Scheduling versus Triage:

The concept of scheduling is fundamentally at odds with the medical community's triage protocols. The fact that a patient is scheduled for a certain treatment at a certain time is irrelevant if a patient with more critical healthcare issues requires the same resources. As medical needs require changes in patient schedules, nurses must step-in to modify the schedule. Often, nurses abandon any pretext to following a time-based schedule and simply take patients in the order in which everything is ready to treat a patient, i.e., all resources are available and the patient is ready for treatment, unless prioritized by a medical need.

Other Scheduling Dynamics:

There are several additional classes of events that normally and regularly change a patient's schedule including, but not limited to: patient re-prioritization (e.g. due to acuity), variations in treatment times (e.g. an elderly patient may take twice as long as a young, ambulatory patient), unscheduled patients (e.g. walk-ins and add-ons), unintentional over booking (e.g. double booking physician slots), variations in laboratory testing times, and so forth. Each of these issues requires nurses to intervene and determine how best to deal with all of the patients waiting for treatment. As noted previously, many nurses simply abandon any attempt to reconfigure the schedule and simply take patient in the order in which everything is ready to treat a patient, i.e., all resources are available and the patient is ready for treatment, unless prioritized by a medical need.

Operational Cost of Scheduling to Nurses:

Patient scheduling creates an enormous administrative and management load on the nursing staff. While patient schedules may create an initial, official schedule, nurses must modify that schedule as the day brings change after change. Nearly every scheduling function is a manual process, often carried out with paper and pencil through a collection of sign-in sheets, nurse assignment sheets, unit-level patient schedules (often a sheet of paper carried about by the charge nurse), and other ad-hoc organizational and coordination tactics. When nurses must collaborate to find scheduling solutions for one or more patients, they do so through a series of phone calls and voicemail messages. All of these operations take time away from clinical tasks, often for entire groups of nurses engaged in logistical collaboration.

Collaboration Among Caregivers

Providing patient care inevitably requires the collaboration of many caregivers, each of whom specializes in a care function. These caregivers are generally distributed throughout a healthcare facility, potentially in a different healthcare facility, or some other offsite location, such as a laboratory. The process of effectively collaborating among a distributed group of caregivers introduces yet another source of inefficiency associated with the costs of communication.

Collaborative Forms:

Caregivers may collaborate directly, (e.g. through synchronous or asynchronous voice or text communications) or through patient data (e.g clinical orders, treatment plans, etc.).

Cost of Data Access:

Caregivers access patient data through a combination of electronic and paper records. Very few modern healthcare facilities have moved entirely to electronic records. Certain medical specialties (e.g. radiology) make more prevalent use of electronic records than others. Data access generally requires caregivers to physically move to points of data access (e.g. computer terminals or patient charts), which are commonly collected at the nurses' station or similar clinical office setting in order to input or retrieve data.

Current approaches require nurses to spend significant amounts of time traveling between clinical treatment sites (e.g. patients' rooms) and the data location. If the data is electronic, then the nurse must further expend effort to e.g. log-in, open a program, access data through potentially multiple menus, optionally print the data, close the program, and log out. If the nurse moves to the treatment site and notes that she has forgotten to access all the necessary data, then she may need to return to the nurse's station and perform e.g. all of the same steps a second time.

Cost of Data Availability:

Caregivers are not guaranteed that the data that they seek is actually available within the electronic system. They must therefore bear the aforementioned costs of data access without a guarantee that such costs will not be wasted in a fruitless search for data that is not yet in the system. Caregivers may bear such cost multiple times before the data does become available.

Such a scenario matches the so-called “Variable Reward Schedule” which acts to reinforce the data-checking behavior. In other words, nurses experience a psychological reward each time they obtain data from the IT system, after requesting the data a variable, random number of times. Such reward systems act as psychological reinforcements to check for data, which would then tend to cause nurses to waste time checking for data over-and-over again.

Cost of Connecting with a Resource:

Caregivers must collaborate with one another in order to make both clinical and logistical decisions in support of executing a patient's treatment plan. Currently, caregivers communicate with one another through telephones, pagers, and other similar telecommunications equipment. Pagers are often located on the caregiver, while telephones, like computers, are often located in nurses' stations or other central locations, requiring nurses to travel from treatment sites to communications sites in order to collaborate.

In order for one caregiver to form a connection with another, they must generally page that resource, requesting that that resource call a certain number. That resource must complete a task then travel to their central location and place the call. If too much time has elapsed, then the first caregiver may have moved away from their central location and be unavailable when the call comes in. Phone tag ensues.

The cost of connecting with a resource is increased if the first caregiver does not know which specific caregiver in the other unit can help to answer their question. It is often the case that a nurse will call another Unit (such as a lab) to make an inquiry (e.g. what is the status of the blood sample that I sent down 2 hours ago). If they do not know the precise person in the Unit who has that information or knows how to access it, then the person answering the phone in the Unit must inquire among their staff until they can locate someone who can help.

The cost of connecting with a resource is therefore at least (i) the cost of getting both parties onto the same call at the same time, plus (ii) the cost of locating the right parties in both Units, where “right” is defined to be the party in possession of the needed information.

Cost Overhead of Requests:

There are certain requests that nurses regularly make throughout the day, e.g. requesting that medical records pull and deliver a patient's chart, or e.g. inquiring the status of a particular patient's blood chemistry results from the laboratory. Current methods generally do nothing to reduce the overhead associated with these normal inquiries that nurses make day after day. As one example, a nurse who wants to request a patient's chart must page medical records with the patient's internal ID number—a process that requires going to a computer, logging in, opening an email program, writing an email to a pager, finding the patient's ID on any other document (because she doesn't have the chart), including the ID in the email, sending the email, and waiting for the reply.

Where people working together in-person have opportunities to reduce the overhead of making requests of one another, the same does not apply when those requests must be made via communications systems to persons at a distance. These systems add a cost overhead to the performance of requests across the system—a cost that generally cannot be reduced without changing the logistical efficiencies of the system itself.

Need for a Different Approach

Impact on Patient Care:

Each inefficiency in patient scheduling and caregiver collaboration consumes caregiver time. Caregiver time is either outright wasted (e.g. as in collaboration overhead costs), or is applied to logistics management functions rather than clinical care functions (e.g. as in constantly re-doing patient and/or staff schedules in response to changes in patient census, acuity, or external forces). Factors that affect patent scheduling are discussed in greater detail hereinafter.

Ad-hoc Approaches further consume Nursing Time:

Until new approaches to (i) patient scheduling and (ii) caregiver collaboration are developed that appropriately deal with the complexities of care logistics management, the caregiver staff must continue to expend large portions of their time to create ad-hoc processes and methods to deal with the patient backlog created by a malformed schedule or inefficient collaboration. Despite their best efforts, they can do little more than fight fires, a highly appropriate euphemism for dealing with the immediate problem in isolation because there simply isn't time to deal with the source of that problem.

### SUMMARY OF THE INVENTION

Automating the decision-making associated with Care Logistics Management (CLM) through the application of an intelligent system offers two immediate benefits. First, freeing nurses from CLM tasks and re-purposing that time to direct patient care immediately increases the direct care capacity of the healthcare facility, without requiring additional investment in infrastructure. Second, it is very likely that intelligent systems can produce far more optimal logistics plans than a large, highly distributed group of very busy nurses.

A method of controlling patient care logistics comprises: (a) providing a programmed computer; (b) providing a plurality of user devices in operative communication with the computer; (c) causing the computer to determine for each user device a unique priority sorted list of queue tasks for the user of said user device, wherein each unique priority sorted list of queue tasks is determined on the basis of global or sub-global criterion that affect the determination of the priority sorted lists of queue tasks for the plurality of user devices; (d) dispatching to each user device the unique priority sorted list of queue tasks determined for said user device in step (c); (e) the computer receiving a change in at least one global criterion; (f) causing the computer to determine for a subset of the user devices on the basis of the change received in step (e) either an amendment to the unique priority sorted list of queue tasks determined in step (c) for each user of said subset of user device or a new unique priority sorted list of queue tasks for each user of one the user devices of said subset of user devices; and (g) dispatching to each user device the unique priority sorted list of queue tasks determined for said user device in step (f).

The method can further include repeating steps (e)-(g). The global criterion can include tasks or patient assignments allocated to the user's of said user device by the computer.

The method can further include the computer being responsive to user activation of a first one of said user devices for causing said first user device to be coupled in communication with a second one of said user devices.

The first and second user devices can be coupled in wireless communication with each other.

The computer can determine the second user device to connect in communication with the first user device based on a role of a user of the second user device.

The change in the at least one global criterion can include a change in at least one of the following: physician's order, patient diagnosis, patient treatment plan, patient wait times, staffing level; care load; patient census; patient acuity; patient flow; patient present rate; bed availability; task assignment; task completion; caregiver skills; patient priority needs; a location of an object; time of day; day of the week; local weather; disease progression; and an emergency condition.

The change in the at least one global criterion can originate at one of the following: one of the user devices; a passive measurement device; an active measurement device; or another computer.

Also disclosed is a patient care logistics control system comprising: a logistics software program; a server computer operating under the control of the logistics software program for sequentially determining plural sets of priority sorted lists of queue tasks, wherein each set of priority sorted lists of queue tasks is determined in response to a change in at least one criterion used for determining the priority sorted lists of queue tasks; a plurality of intelligent wireless user devices, each user device including a visual display; and a wireless network connecting the server computer and the user devices and operative for wirelessly delivering for display on the display of each user device for each set of priority sorted lists of queue tasks a unique one of the priority sorted list of queue tasks on the basis of the user assigned to the user device or a role of a user assigned to the user device.

The wireless network can include radio transceivers associated with the user devices and the server computer.

The server computer can cause the wireless network to couple two user devices in communication.

The change in at least one criterion can originate at one of the following: at the server computer; one of the user devices; a passive measurement device; an active measurement device; or another computer.

The criterion used for determining the priority sorted lists of queue tasks can include at least one of the following: staffing level; caregiver patient load; patient census; patient acuity; patient flow; patient present rate; bed availability; caregiver task assignment; caregiver task completion; caregiver skills; patient priority needs; a location of an object; time of day; day of week; local weather; disease progression; or an emergency condition.

Each priority sorted list of queue tasks can be wirelessly delivered to its user device in real-time.

The plural sets of priority sorted lists of queue tasks is determined based on plural service queue models included in the logistics software program, wherein each service queue model includes tasks to be performed by a caregiver on or for the benefit of at least one patient.

Two priority sorted lists of queue tasks delivered to one user device includes a change in a priority of at least one task.

Also disclosed in a method of controlling patient care logistics comprising (a) providing a programmed computer; (b) providing a plurality of user devices in operative communication with the computer; (c) modeling on the programmed computer patient care as a multitude of queue tasks to be performed by a plurality of users, wherein each user has an associated role and carries a user device; (d) receiving modeling criterion via one of the following: one of the user devices; a passive measurement device; an active measurement device; or another computer; (e) causing the computer to run logistics management software to determine for each user device a unique priority sorted list of queue tasks for the user of said user device based on the patient care model, wherein each unique priority sorted list of queue tasks is determined on the basis of the modeling criterion; (f) dispatching to each user device the unique priority sorted list of queue tasks determined for said user device in step (e); (g) the computer receiving a change in at least one criterion; (h) causing the computer to run the logistics management software to determine for each user device on the basis of the change received in step (g) either an amendment to the unique priority sorted list of queue tasks for the user of said user device determined in step (e) or a new unique priority sorted list of queue tasks for the user of said user device; and (i) dispatching to each user device the unique priority sorted list of queue tasks determined for said user device in step (h).

The method can include the computer responsive to user activation of a first user device for causing said first user device to be coupled in communication with a second user device. The first and second user devices can be coupled in wireless communication with each other.

The method can further include (j) assigning the role of a user to the user device of said user; wherein the computer determines the second user device to connect in communication with the first user device based on the role of a user of the second user device.

The change in the at least one criterion can include a change in at least one of the following: physician's order, patient diagnosis, patient treatment plan, patient wait time, staffing level; care load; patient census; patient acuity; patient flow; patient present rate; bed availability; task assignment; task completion; caregiver skills; patient priority needs; a location of an object; time of day; day of the week; local weather; disease progression; and an emergency condition.

The change in the at least one criterion can originate at one of the following: one of the user devices; a passive measurement device; an active measurement device; or another computer.

The method can further include: (k) defining for a patient a set of roles based on the requested patient care; (l) linking in a database the patient to one or more user devices on the basis of the set of roles; (m) initiating an activity for said patient resulting in one or more queue tasks for one or more roles; (n) causing the computer to run the logistics management software to determine for each user device on the basis of the one or more queue tasks generated in step (m) either an amendment to the unique priority sorted list of queue tasks for the user of said user device determined in step (e) or step (h) or a new unique priority sorted list of queue tasks for the user of said user device; (o) receiving criterion indicating that examination results of said patient have been made available in the programmed computer; (p) determining a first user device having a queue task associated with said examination results; and (q) instructing the first user device determined in (p) to inform the user that the test results have been made available.

The computer can determine a second user device to connect in communication with the first user device based on a role of a user of the second user device.

Lastly, disclosed is a patient care logistics control system comprising: a logistics software program; a plurality of intelligent wireless user devices, each user device including a visual display; a server computer configured to model patient care as a multitude of queue tasks to be performed by a plurality of users, wherein each user has an associated role and carries a user device, the server computer further configured for receiving criterion via one of the following: one of the user devices; a passive measurement device; an active measurement device; or another computer, wherein the server computer is operating under the control of the logistics software program for sequentially determining plural sets of priority sorted lists of queue tasks for the user a user device based on the patient care model, wherein each set of priority sorted lists of queue tasks is determined on the basis of the criterion; and a wireless network connecting the server computer and the user devices and operative for wirelessly delivering for display on the display of each user device for each set of priority sorted lists of queue tasks a unique one of the priority sorted list of queue tasks on the basis of the user assigned to the user device or a role of a user assigned to the user device.

The server computer can be configured to assign a role of a user to the user device of said user and to causes the wireless network to couple two user devices in communication based on the roles of at least one said user associated with said user devices.

The change in at least one criterion can originate at one of the following: at the server computer; one of the user devices; a passive measurement device; an active measurement device; or another computer.

The criterion used for determining the priority sorted lists of queue tasks can include at least one of the following: physician's order, patient diagnosis, patient treatment plan, patient wait time, staffmg level; care load; patient census; patient acuity; patient flow; patient present rate; bed availability; task assignment; task completion; caregiver skills; patient priority needs; a location of an object; time of day; day of the week; local weather; disease progression; and an emergency condition.

Each priority sorted list of queue tasks can be wirelessly delivered to its user device in real-time.

The plural sets of priority sorted lists of queue tasks can be determined based on plural service queue models available to the logistics software program, wherein each service queue model represents tasks to be performed by a caregiver on or for the benefit of at least one patient.

Two priority sorted lists of queue tasks delivered to one user device includes a change in a priority of at least one task.

The server computer can comprises a processor, and memory with data, and instructions stored therein so that the computer can execute a predetermined program wherein the program is arranged to enable the processor: to define for a patient a set of roles based on the requested patient care; to link in a database the patient to one or more user devices on the basis of the set of roles; to initiate an examination for said patient resulting in one or more queue tasks for one or more roles; to cause the computer to run the logistics management software to determine for each user device on the basis of the one or more queue tasks generated either an amendment to the unique priority sorted list of queue tasks for the user of said user device or a new unique priority sorted list of queue tasks for the user of said user device; to receive the criterion indicating that examination results of said patient have been made available in the programmed computer; to determine a first user device having a queue task associated with said examination results; and to instruct the first user device determined to inform the user that the test results have been made available and wherein the first user device is configured to inform the user in response to the instruction generated by the server computer.

The program can be further arranged to determine a second user device to connect in communication with the first user device based on a role of a user of the second user device accessible to the computer, and to transmit an identification information associated with the second user device to the first user device, wherein the first user device is configured to receive the identification information associated with the second user device and to connect with the second user device based on said identification information.

### BRIEF DESCRIPTION OF THE DRAWINGS

FIG. 1 is a block diagram of a system in accordance with the present invention; and

FIG. 2 is a block diagram of the elements comprising each handheld device in FIG. 1.

### DETAILED DESCRIPTION OF THE INVENTION

Disclosed is a system for creating significant new operational efficiencies within a hospital environment. In general, the system has at least the following integrated capabilities:
Networked, Distributed, Role-based Communications—Caregivers are linked through a distributed communications network (in one desirable embodiment, through the use of portable handheld processing and wireless communication devices (hereinafter “handheld device”, “handheld devices”, “mobile device”, “mobile devices”, “user device”, or “user devices”) such as, but not limited to, devices like the Apple iPhone® or similar (iPhone® is a registered trademark of Apple Inc. of Cupertino Calif.)) that connects caregivers to one another through an automated, role-based directory, as well as to non-human agents that perform automated non-clinical management functions. Such units also connect caregivers to relevant healthcare data, allowing them to generally input, retrieve and operate on data, including but not limited to patient medical data, patient logistical data, billing data, insurance data, general medical data, etc. In certain applications patients may also be linked into this network.
Automated Care Logistical Management—The system enables a variety of logistical tasks, normally performed manually by a caregiver, to be automated and integrated into the system in generally any location in the network—e.g. on the clinician's local machine, on a server computer, or even divided among several network machines Hereinafter, the logistical tasks used to effect automated care logistics management in accordance with this disclosure will be described as being integrated (programmed) into a server computer 4 (described hereinafter) which operates under the control of its logistical programming to perform automated care logistics management in the manner described hereinafter. However, this is not to be construed as limiting the invention since it is envisioned that the logistical tasks used to effect automated care logistics management can reside on one or more networked computers as necessary. Accordingly, the particular hardware arrangement described herein is not to be construed in any manner as limiting the invention. Each clinical management function may be enabled to operate as an individual application.
Virtual Representation of Logistical State—The system gathers information from both its users and from integrations into various user IT systems to build and maintain a cohesive virtual representation of the logistical state of the healthcare system or unit of interest.
Local and/or Global Optimal Decision Making—The system performs optimal decision making at any level within the logistical chain. Decisions may therefore be made optimal in consideration of only local conditions, or “global” optimality may be determined within a definable “global” subsystem that comprises all or only a portion of the total system.
Prediction & Simulation—The system maintains one or more internal predictors and/or simulators whose function is to predict future logistical states, such information can then be used, e.g. to warn the group of potential future problems, such as the likelihood that the Emergency Room will be jammed within the next 3 hours, or e.g. to determine the future resource needs of all patients within a particular subgroup of the healthcare facility.
Learning—The system uses logistical information to continually learn about its internal representations of the individual healthcare system to which it is attached. In this sense, the virtual representation may be calibrated, aligned with, or otherwise customized to the particular logistical behaviors of an individual healthcare unit. In addition, learning at a higher level, for example, across groups of healthcare facilities, or a system of logistically interconnected but physically separated facilities is supported.
Dynamic Labor Scheduling—The system automates the processes of scheduling labor, on varying time-scales, and with the capacity for dynamically updating projected labor needs in consideration of changes in the logistical state of the healthcare system of interest.
Dynamic Resource Scheduling—The system automates the process of scheduling resources, including but not limited to rooms, (e.g. OR's, gastro labs, cardiac catheterization labs, in-patient bed space etc.), equipment (e.g. MRI machines, CAT scanners, respirators, wheelchairs & gurneys, etc.) and other physical objects required to deliver patient care.
Dynamic Patient Scheduling—The system automates the creation of logistically realistic patient schedules, dynamically updating such schedules as disturbances force changes to those schedules.

Networked, Distributed, Role-based Communications:

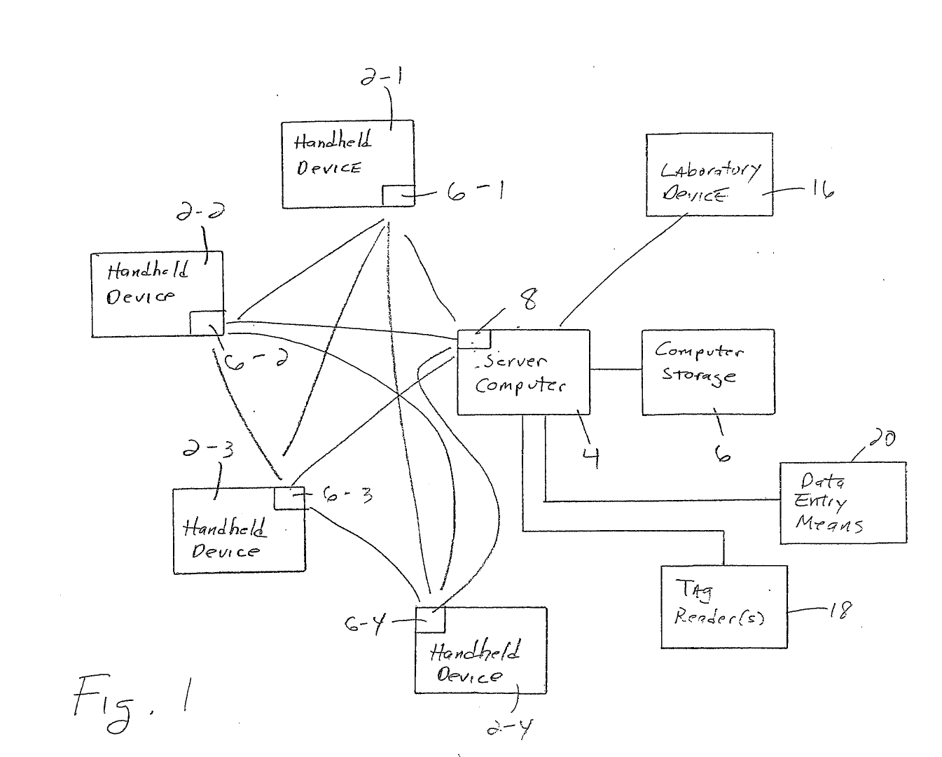

With reference to FIG. 1, an exemplary, non-limiting, system includes a plurality of handheld or mobile devices 2 in communication with a server computer 4 that has access to a computer storage 6. Each handheld device 2 includes a wireless transceiver 6, and server computer 2 includes or is coupled in operative relation to a wireless transceiver 8. Each transceiver 6 is operative for establishing two-way communication with each other transceiver 6 and with transceiver 8. Similarly, transceiver 8 is operative for establishing two-way communication with each transceiver 6.

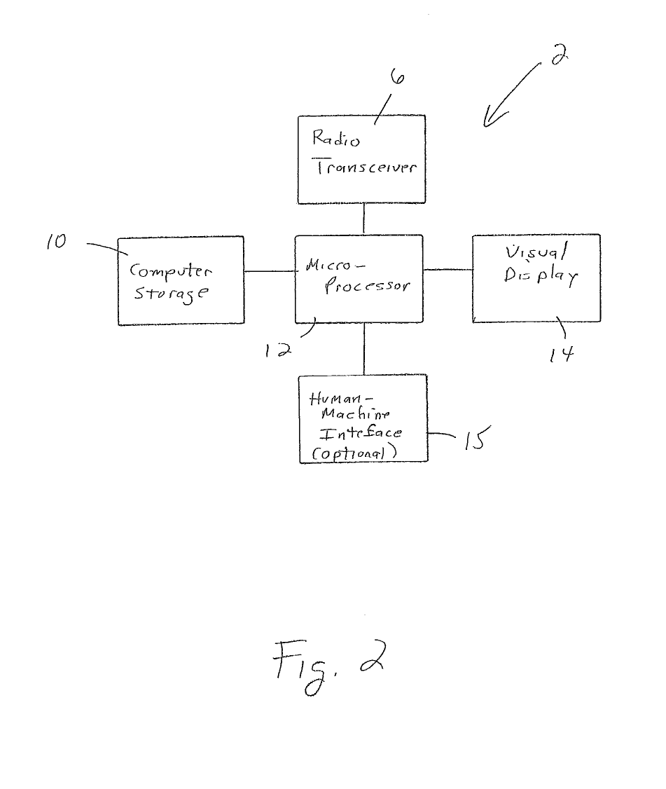

With reference to FIG. 2 and with continuing reference to FIG. 1, each handheld device 2 includes, in addition to a transceiver 6, a computer storage 10, a microprocessor 12 and a visual display 14. Microprocessor 12 is programmed in a manner known in the art to control the operations of transceiver 6, computer storage 10, and visual display 14. Desirably, visual display 14 is a touch screen display operating under the control of the programming of microprocessor 12 to display one or more virtual buttons, each of which can be activated by a user of the handheld device 2 in a manner known in the art to cause microprocessor 12 to perform a function associated with said virtual button. Also or alternatively, each handheld device 2 can include a human machine interface (HMI) comprised of one or more buttons (e.g., a keyboard), a track ball, and the like known in the art to facilitate user input of data into handheld device 2. Handheld device 2 can also include telephone functions such as those found in a standard cell phone.

The handheld devices 2 and server computer 4 can be operative for implementing a distributed communication network architecture. In one non-limiting embodiment, this distributed communications network architecture is a peer-to-peer architecture. In another non-limiting embodiment. the communication network architecture can be a centralized server based architecture.

In the peer-to-peer architecture, each handheld device 2 can be placed by server computer 4 into direct one- or two-way communication with one or more other handheld devices 2. In the centralized server-based architecture, all communications from between handheld devices 2 is routed through server computer 4. Since such architectures are well known in the art, details regarding such architectures will not be described herein for purpose of simplicity. Desirably, the present invention is implemented as a peer-to-peer architecture.

The system described herein enables clinical staff to save enormous amounts of time that is usually lost in the series of phone calls, voice mails, and database look-ups required to coordinate patient care. The system moves beyond telephones, pagers, and PDA's as passive communications systems (e.g. systems that require humans to decide to make calls to one another) to an active logistics management platform, e.g. a distributed communications platform that provides both active and passive means of collaborating around the performance of CLM tasks.

Integrated Communications & Mobile Computing with Push Data:

Efficient care logistics calls for the use of distributed (i.e. mobile) computing and communication that comprises: (i) automatically performing logistics functions in lieu of humans performing them; (ii) provides access to other sources of logistics data and/or knowledge (e.g. both people and electronic), and/or (iii) supports communications with other nurses. The use of a distributed computing and communication platform is desired because keeping such platform with the caregiver eliminates much of the time spent physically moving back and forth to telephones and data sources—a source of improved operational efficiency.

Such platform may also be used to take in patient medical information as an input to a patient database stored in a computer storage and accessible to each handheld device, wherein the computer storage operates under the control of at least one server computer. The system desirably employs a push data model in which handheld device's 2 carried by caregivers, such as, without limitation, hospital nurses, an ambulance crew member, and/or another clinician not part of the hospital, are proactively informed by server computer 4 of the progress of other queues upon which the progress of their own work tasks depend.

For example, a treatment nurse would carry a handheld device 2 that displays on a display 14 thereof a proposed, priority sorted list of queue tasks provided to handheld device 2 by server computer 4 (where priority is established on the basis of global of sub-global criteria available to server computer 4). In this manner, handheld device 2 would (i) proactively alert the nurse when dependent tasks in other queues are completed (for example, it might alert her that blood test results are now available for one of her patients), (ii) enable the nurse to check on other logistics information, for example, the estimated time of arrival on blood samples for a second patient, and (iii) it would further provide the capability to directly connect the nurse with a laboratory device 16, such as a stationary computer or a handheld device, disposed in the laboratory or belonging to a laboratory personnel (e.g. through any of voice, text, sms, instant messaging, or other means) to discuss those lab results before moving on to treat the patient. Each handheld device 2 can also display on its display 14 any other suitable and/or desirable information such as, without limitation, a treatment checklist for one patients supplied to the handheld device 2 by the server computer 4, an electronic chart analogous to a bedside chart for one or more patients, and the like.

Role-based Collaboration:

The efficiency of a facility's nursing staff is often driven by personal relationships between nurses in different units. Personal relationships generate efficiency improvements simply because the nurse knows exactly who to call in the other unit in order to get help with an issue at hand—i.e. the nurse knows the exact person that performs the healthcare role that they need to collaborate with in order to treat their patient. Role-based collaboration is already used by physicians to collaborate in patient care. For example, when an attending physician determines that he or she needs additional expertise in, e.g., cardiology, they request a consult from the on-call cardiologist, who comes to the patient and collaborates in the diagnosis. Caregivers would benefit from a similar capability for logistical collaboration.

The present invention integrates direct person-to-person (or group) communications driven by caregiver roles. For example, rather than having to know that Nurse Smith in radiology is the correct nurse to help coordinate the transport of a patient to and from radiology, a nurse in a medical/surgical unit could simply press a real or virtual button on her handheld device 2 that causes the handheld device 2 to be linked to the handheld device belonging to the logistics collaboration nurse in radiology—regardless of the identity that nurse at that time. To this end, server computer 4 can be programmed to track which nurse presently on-duty fulfills the role of the logistics collaboration nurse in radiology, e.g., via a directory accessible to server computer 4 that includes the identity of the on-duty logistics collaboration nurse in radiology. Thus, in response to a first nurse in the medical/surgical unit pressing on her handheld device 2 the button associated with the collaboration nurse in radiology, server computer 4 determines which employee presently on-duty is the logistics collaboration nurse in radiology and retrieves from computer storage 6 the network address (or phone number) of said collaboration nurse's handheld device 2 and causes said handheld device 2 to be placed into one- or two-way communication with the handheld device 2 of the first nurse. In this manner, nurses can quickly reach a desired role counterpart in any unit of the hospital in order to collaborate in the solution of logistics problems. Moreover, the state information surrounding the requesting nurse's queue can be used to both: (i) direct the connection to the appropriate resource automatically, and (ii) provide precise supporting information to that resource to help speed the resolution of the issue.

This allows for the automation of direct communications based on an electronic directory to match a caregiver role to the handheld device 2 belonging to the person who (today, or during this shift) is assigned to carry out that role. Such directory can be dynamically updated by server computer 4 as role assignments (or staffing assignments) change throughout time.

Virtual Teams:

Role-based collaboration can be a powerful concept in care logistics management. Using the system described herein, this concept can be expanded from caregiver-to-caregiver single-issue collaboration to the creation of virtual teams of caregivers associated with the continuum of a patient's treatment. A virtual team may be formed (and accessible in a database accessible to server computer 4) around any clinical, logistical, or other issue that requires representatives of one or more areas to work as a team, while potentially physically distributed throughout the healthcare facility or beyond the facility.

For example, the patient may have a virtual team assigned to him or throughout the entire continuum of care, or only at specific stages. The members of the patient's team can change as the patient's needs change. Different members of the team will be active in managing the logistics of a patient's care at different stages of treatment, but any team member can be pulled into the collaboration on a moment-by-moment basis as their participation is required. Such participation can be scheduled far in advance, using the power of predictive modeling (described later), or it can be called in on a stat-basis when, for example, a patient codes and requires emergency transport.

Server computer 4 can assemble a virtual team as a background process, meaning that the creation of the team will not require the active collaboration of any caregiver, until such time as his or her participation in a particular clinical, logistical or other issue is required. Thus, the virtual patient team provides for a new level of collaboration at no additional time cost to the caregivers involved.

Under the control of server computer 4, one- or two-way communication can be established between two or more handheld device 2 of members of any virtual team in a manner similar to the establishment of communication between two nurses described above in connection with role-based collaboration.

Extension beyond Caregivers

Other healthcare stakeholders may be integrated into the networked communications system described herein with the same or different capabilities as caregivers. As one example, an ambulatory patient at an outpatient clinic may use a handheld device 2 to receive schedule updates, wait time estimates, or other relevant information. Similarly, the family of a patient might use a similar handheld device 2 to be informed via server computer 3 of the status of a loved one's treatment; coordinate drop-off or pick-up; or otherwise communicate with caregivers.

Generalized Applicability:

Herein, we have referred to healthcare providers as caregivers, healthcare system, healthcare facility, and other similar names It is to be understood, however, that the system herein disclosed can be applied across any general healthcare system, including but not limited to: hospitals, nursing homes, physical therapy centers, outpatient clinics, government healthcare agencies. insurance companies, pharmacies, drug manufacturers, physicians, dentists and other provider offices, clinics, express clinics, and so forth, without regard to physical location, corporate affiliation, or other classification. This system as disclosed enables the management of care logistics across any group of providers.

Automated Care Logistics Management:

Our approach is to automate the performance of as many Care Logistics Management functions as possible, with the objective of freeing caregiver time normally expended on CLM tasks such that it can be re-applied to patient care. The system disclosed herein enables automated CLM tasks to be integrated at any level of the network, e.g. to operate on any subgroup of caregivers, using information from any healthcare information systems, in the manner of so-called “Cloud Computing.” Different hierarchical levels of healthcare management may operate on the “Cloud” of logistical data in different manners to meet their individual management needs.

Caregiver Logistics Management:

Caregivers need: (i) to manage the logistical status and needs of their patients; (ii) collaborate with other caregivers to perform clinical and non-clinical functions; and (iii) manage the priority assigned to the first two items. One example of how these management functions are used by caregivers in the performance of their clinical duties will now be described:

The “Cloud” of logistical data is processed by server computer 4 such that a priority queue for individual caregivers is determined, maintained and updated by server computer 4, in accordance with methods for establishing such priority disclosed in subsequent sections. The priority queue can be dispatched to the handheld device 2 of each individual caregiver automatically, on demand, or both. Caregivers may then review this queue and determine which priorities they will next attend to. Such capability is novel to the healthcare industry. Caregivers benefit from the automated generation of such a priority queue in that it offloads them from forming priority lists themselves, a task that (i) often takes significant time, and (ii) often suffers from incomplete information about the impact of their local priority on the operational performance of the overall healthcare system in which they operate.

For each activity in a priority queue, the system described herein provides associated communications connections to the handheld devices 2 of all members of the virtual team who are necessary to carry out each item in the caregivers' priority stack or queue. The caregiver thus saves the time that would have otherwise been spent finding the appropriate data and connecting to other caregiver collaborators. The caregiver team may therefore progress to the actual clinical collaboration more quickly.

Upon completing the clinical collaboration, one or more caregivers may then decide to take logistical actions, comprised of, for example,: (i) scheduling a patient for an additional treatment; (ii) changing a patient's status to indicate that they may now be admitted, discharged, have been born or expired, or should be transferred to another unit within this or another healthcare facility; (iii) request the inclusion of one or more additional caregiver roles to the patient's virtual team.

Caregiver Managers:

Caregiver managers, (e.g. nursing managers, clinical managers, pharmacy managers, etc.) need to balance clinical care demands against the number of caregivers under their charge. Such caregiver managers therefore need to: (i) assign caregivers to patients; (ii) establish ratios or limits of patients to individual caregivers; (iii) request additional caregivers or fewer caregivers in response to changes in patient census. Next, one example of how these management functions might be used by caregiver managers in the performance of their duties will be described.

The “Cloud” of logistical data is processed to determine a “present rate”, e.g. the rate or schedule at which patients are expected to present requests to individual Units within the healthcare facility. In this context, a patient “presenting” indicates that a request for patient care is made (e.g. by a patient signing in at an outpatient center, an emergency department (ED) nurse requesting that a patient be admitted to the hospital and transferred to a medical/surgical unit, a patient's medications being ordered from pharmacy, a pre-existing physician's schedule etc.) of a Unit within the hospital.

A CLM function implemented by server computer 4 is to assign patient requests of a Unit to individual caregivers within that Unit, with the objective of creating an assignment that preserves some optimality criteria established at the local or global level. The “Patient Assignment” function for a particular unit therefore assigns patient care tasks to the priority queue task list of individual caregivers, possibly after analyzing the contents of those queues, and other information about the individual caregiver necessary to determine that the caregiver was the optimal choice for the assignment.

Healthcare facilities and/or individual caregiver managers may establish limits on the number of patients, patient requests, or other similar “demands” that can be placed on an individual caregiver. For example, ICU and Labor & Delivery nurses traditionally care for at most 2 patients. As another example, Nursing Managers may determine that a particular nurse should not have more than 4 patients, when other nurses have 6 patients, because that particular nurse has patients with significantly higher needs that will require more of her time. Such limitations on priority queue can be created within the “Cloud” by inputs from individual managers to be applied to: individual caregivers; hospital policies applicable to all caregivers of, e.g., a particular functional role; or any other assignment to individuals or groups. Such information is then used as inputs to CLM functions, discussed hereinafter.

A healthcare facility may alter its caregiver resources in response to changes in patient census and acuity, or other factors via server computer 4. A CLM function that can be implemented by server computer 4 is to manage a representation of labor needs to provide care for patients and, further, to manage the process by which additional labor is requested (e.g. from internal flexible labor pools, agencies, traveling nurses, etc.) or called-off. Of particular interest is the need to make labor scheduling decisions in the face of contract rules, health department regulations, hospital policies, and other similar requirements.

Business Analysis:

Healthcare administrators need to understand (i) the current operational efficiencies of their healthcare system; (ii) bottlenecks or points of inefficiency of the systems; and (iii) priority or emergent issues that endanger the facility's capacity to provide healthcare either now or in the future.

A CLM function that can be implemented by server computer 4 is to process the “Cloud” in order to understand the current patient flow status, points of inefficiencies, and/or emergent problems that require administrative attention. As one example, understanding that the current present rate in the Emergency Department will cause it to saturate and need to turn away patients within the next six hours, if unaddressed, could enable administrators to take corrective action.

It is also a CLM function implemented by server computer 4 to both provide such analyses as well as to provide recommendations of changes that could be made in priorities and/or resources to address emergent problems. In continuing this example, the CLM function implemented by server computer 4 might suggest that, given this rate of emergency department patient presents, the facility raises the priority levels of emergency department and associated step-down unit discharges in order to make more emergency department beds available. Server computer 4 might also recommend assigning additional flex staff resources to handle these higher priority issues. If such recommendations are approved (or if server computer 4 is configured such that its recommendations are automatically executed) then a further CLM function is to manage the execution of these priority changes and notifications to labor resources, e.g., via the handheld devices 2 of these labor resources.

A Virtual Model of Logistical State:

Server computer 4 determines a virtual model of the logistical state of the hospital system, based on a framework of connected hospital units, each of which has an associated service queue representing patients who will need to use that hospital unit. The service queue of each hospital unit is further broken down into a local queue model, representing the individual clinical services (units) appropriate to that particular hospital unit. For example, an oncology unit may be modeled as a set of six service queues, each corresponding to an oncology treatment nurse. A radiology unit may be modeled as a set of three queues, each representing a triage nurse, in series with a set of four queues, each representing a particular radiological scanning device, e.g. CAT scan, X-Ray, MRI, etc.

Modeling Caregivers as Service Queues:

Herein the terms patients, patient needs, patient tasks, and other similar phrases will be used interchangeably to mean the patient himself or herself, or care (such as a pharmacy order) for that patient. It is important to note that the use of one or the other term is not intended to in any way limit the generality of the description.

A single caregiver is generally responsible for caring for multiple patients or patient tasks at one time. For example, normal patient to nurse ratios are 6:1 for non-critical acuity patients, and 2:1 for critical acuity patients—e.g. labor & delivery, critical care units, cardiac care units, etc. Each nurse must provide both clinical care for these patients as well as perform care logistics functions for both their current patients as well as new patients who are being transferred to their care. As another example, a hospital pharmacist may have orders for a dozen or more patients at any one time.

Caregivers generally are in-process on a number of tasks at the same time—in-process tasks are tasks that have been started, are not yet completed, and are being worked on in a piecemeal fashion along with several other in-process tasks. For example, a nurse may begin to admit one patient, while waiting for the results from a blood test for a second patient. When those results do arrive at the nurse's handheld device 2, the nurse may interrupt that admission in order to review the blood results to see if that patient will be able to be discharged. If so, she will inform a nurse assistant to begin the discharge paperwork. The nurses' other four patients may require no care at that time, or may also have a treatment or charting function that simultaneously requires the nurse's attention.

The system models the nurse as a service queue in which multiple tasks are managed in a manner similar to methodologies used to manage processor tasks in microprocessor control, using the methods of queue theoretic modeling. As a practical matter, the resolution or granularity of the tasks in the queue must be selected so that they best benefit the caregiver in the performance of their work. Too fine detail will simply result in useless micro-management, while too high level will result in insufficient ability to truly prioritize among competing tasks. A preferred embodiment is to model tasks on the level of competing treatment or logistics tasks, such as “Admitting a Patient”; “Discharging a Patient”; or “Perform a CAT Scan”, as each such task has a well-understood clinical and/or logistical process that may not benefit from further delineation.

Assigning Patients to Service Queues:

Via server computer 4, caregiver managers assign patients or patient tasks to caregivers as said caregivers process from unit-to-unit, generate new needs, and/or as caregivers change shifts. Patient assignments are essentially server computer 4 implemented methods of (i) assigning a patient or patient task to an initial service queue, or (ii) transferring patients or patient tasks from one service queue to another either because they require a different type of care (e.g. transfer to a nurse in a new unit, such as a transfer from labor & delivery to maternity) or because the service queue to which they are currently attached is being closed out (e.g. the nurse's shift is coming to an end and her patients are being transferred to another nurse).

Patient assignments are made based on a set of “load and skill” heuristics that attempt to ensure that patient needs are matched to caregivers who have the skills and experience to provide appropriate care, while ensuring that no nurse is overloaded with patients, and thus lacks adequate time to care for any one patient. Patient assignments are judgments usually made by managers who know his or her staff Thus, automated assignment methods may be used to suggest patient assignments to a nurse supervisor who will approve or reject the assignments, or managers may select to have such assignments automatically approved. The integration of machine learning methods, described later, can be used to observe the types of corrections that the manager makes to patient assignments to: (i) learn better rules, as well as (ii) the constraints that the supervisor typically places on individual nurses.

Adjusting Patient Assignments in Real Time:

As noted earlier, one of the objectives server computer 4 utilizes to make patient assignments is to balance the care load across the staff—both to ensure adequate patient care as well as to ensure that no one caregiver becomes overloaded. As a shift progresses, loads can change tremendously. For example, one nurse may have one or more patients experience sudden changes in acuity, for example, by having a heart attack, an allergic drug reaction, or other major health problem that requires her attention. Less dramatic, but more commonly, a single nurse may have one or more patients who require more significant time and attention because, for example, they are transferring in or out of the unit.

As load balance changes throughout the shift, caregivers rely on one another to (i) notice that they are not overloaded, but their co-worker is; and (ii) go to their co-worker and offer to take on certain tasks to help to relieve the overload. The problem here is that even well-intentioned co-workers may not notice, especially if they are not physically in the same space; not all co-workers are eager to take on more tasks, even if they are the least loaded on the shift; and shifting tasks often requires as much time for the overloaded caregiver to communicate the need to the under-loaded caregiver as it would have taken her to simply do the task.

Server computer 4 may apply methods of automatically generating load-balancing patient assignments in real-time throughout the shift to identify overloaded caregivers; identify those tasks (or indeed, patients) that can be effectively shifted to under-loaded caregivers; and effect part of the communication among staff to suggest or implement the patient assignment change. Supervisors can then leverage such a system to decide among several intervention modes ranging from bringing more staff to temporarily deal with an emergent situation to shifting patients to a different caregiver for the remainder of the shift.

Information regarding the need to change an individual caregiver's care load can be input into server computer 4 in any suitable and/or desirable manner. For example, an emergency condition signal generated at a nurse's station, such as, without limitation, a “Code Blue” signal indicative of a patient in cardiac arrest, is communicated to server computer 4, either via a wired connection or via a handheld device 2. In response to receiving this signal, server computer 4 automatically reduces the care load (number of patients) of the caregiver assigned to the Code Blue patient accordingly to a predetermine rule and reassigns some or all of said caregiver's other patients to one or more other caregivers. Server computer 4 then notifies the handheld device 2 of each caregiver affected by this redistribution of care load. Server 4 can also automatically notify the handheld device 2 of each other caregiver that has been assigned to the team responsible for responding to the Code Blue signal generated at the nurse's station of the Code Blue event and reassign some or all of each of their caregiver's other patients to one or more other caregivers according to a predetermined rule. Hereinafter, such redistribution of care load shall be called “emergency-based care load redistribution”.

In another example, a supervisor may inform server computer 4 (e.g., via the supervisors handheld device 2) that patients can be reassigned to or from a particular caregiver (hereinafter called “supervisor-initiated care load redistribution”). In yet another example, the caregiver herself may inform server computer 4 (e.g., via the caregiver's handheld device 2) that patients can be reassigned to or from said caregiver (hereinafter called “caregiver-initiated care load redistribution”). Desirably, this latter reassignment occurs with the approval of a supervisor, e.g., via the supervisor's handheld device 2.

Lastly, patients can be reassigned to or from a particular caregiver based on historical treatment times. For example, if server computer 4 determines that a caregiver takes more (or less) than an historical, allotted amount of time to complete a series of patient care related tasks, server computer 4 may reassign one or more patients from (or to) a said caregiver to spread the care load among a number of caregivers, either in the same unit or among different units. Hereinafter, such redistribution of care load shall be called “time-based care load redistribution”.

Service Queue Prioritization:

Each caregiver (service queue) must continually determine patient care priorities from among a large number of possible options. For example, a nurse with six patients must continually balance the needs of the patients against each other and against the total amount of time that he or she can spend on the group. Ironically, the time spent gathering sufficient information to make a decision, analyzing that information, and coming to a decision all takes away from the time that can be spent on actual patient treatments!

The caregiver focuses on prioritizing his or her work queue to (i) provide patient care, (ii) document patient care, (iii) manage the logistics of patient diagnostics, patient transfers, physicians' orders, etc. etc. These tasks may be prioritized according to any prioritization criteria including, but not limited to: (i) minimizing patient wait times; (ii) discharging patients; (iii) maximizing patient flow through the unit; (iv) prioritizing high acuity patient care, and so forth.

Service queue priorities must generally be established by authorized clinical managers (e.g., supervisors), and, as noted earlier, caregiver managers are enabled to establish and change prioritization criteria, i.e., supervisor-initiated care load redistribution, in server computer 4 via their handheld devices 2. In addition, server computer 4 itself may suggest or, if authorized, automatically change prioritization criteria in response to the logistical state or predicated state, e.g., emergency-based care load redistribution, or time-based care load redistribution.

Enabling Globally Optimal Patient Logistics Decisions:

Impact of Locally Optimal Decisions:

As discussed earlier, the caregiver focuses on prioritizing his or her work queue to (i) provide patient care, (ii) document patient care, (iii) manage the logistics of patient diagnostics, patient transfers, physicians' orders, etc. These tasks often impact both the caregiver performing the tasks as well as other caregivers, scattered throughout the hospital, who are waiting for that caregiver to perform a certain task that is somehow linked to his or her task list.

As one example, a nurse in one unit may have a patient waiting to be discharged. For whatever reason, she has decided that the task of discharging that patient is her third priority. She does not realize that the bed that that patient will vacate is needed to transfer a patient from a medical/surgical unit whose bed will be then taken by a patient who is waiting to be admitted from the Emergency Department, which is not yet backed up, but is becoming backed up. However, since she isn't aware of how her task prioritization is having a very real effect on the state of the hospital's emergency department, so she has no reason to elevate the priority of that task over others that, to her, seem more important, based on her local, unit-view.

Benefit of Linking Service Queues:

Effective service-queue prioritization links the priority-generating functions of each caregivers' queue to all of the system-wide service queues whose logistics are impacted by his or her prioritization decisions, as well as the availability (either current or future) of key resources necessary to carry out each particular task. Such linkages also enable the identification of the most orthogonal tasks in the caregiver's queue, which are more likely to correspond to tasks that could be more readily offloaded to another caregiver should that caregiver become overloaded.

Generality of Prioritizing across Systems of Queues:

Logistics decisions are currently local. The creation in server computer 4 of a facility-wide, inter-facility-wide, or other virtual representation of the logistical service queues enables the application of queue theoretic approaches to the analysis and optimization of the system of queues in a clinical setting. In other words, server computer 4 can make globally optimal decisions by enabling, for example, a patient's total pathway through the healthcare facility to be considered rather than simply scheduling a patient for labs, a doctor's visit, and treatment and allowing nurses along the way to fit the patient in along with other patients.

The application by server computer 4 of global optimization enables movement away from a nurse-queue centric scheduling system to a true model of overall patient flow through the system by providing, for example, a searchable map of the probable costs of ordering a patient's progress through treatment processes in different ways. (The “cost” of each step in treatment process is a number that is assigned to the treatment process. The total cost of a treatment process is then the sum of the costs of all of the steps of the treatment process.) For example, server computer 4 mapping all possible patient pathways and searching their costs might indicate that a patient should be transferred to one medical/surgical unit rather than another because, for example, it is noted that there is one nurse in the preferred unit who could manage the transfer in 15 minutes, whereas the nursing staff in the other unit will require an hour before any nurse could perform a unit transfer. Upon making this determination, server computer 4 can, via communication the handheld device(s) 2 of one or more caregivers who are directly affected by this determination or have a need to know, cause the patient to be transferred to the medical/surgical unit with the nurse who can manage the transfer in 15 minutes.

Real-Time Measurement of Logistical State:

The logistical state of patients, caregivers, and resources can be estimated, in part, by taking direct measurements of their status. The means of measuring status will vary according to the object type. Three primary object-types and the general approach to measurement for each, along with multiple sensing modes, namely, passive logistics measurements, active logistics measurements, and resource state indicators will be discussed next.

Passive Logistics Measurement: Logistical state may be measured in part through the use of passive measurements systems, such as WiFi tags or any other suitable and/or desirable wireless or optical tag technology, that require no action on the part of the human subject as one measurement mode (e.g., a passive measurement device). Passive measurement has the advantage that it can collect basic information, such as the presence of an object (patient, caregiver, or resource) in key locations throughout the health facility, without requiring that, for example, the patient or caregiver do something. The addition of wireless tags (as one example) to standard hospital bracelets can provide first indicators of which patients are located in specific key spaces throughout the environment, such as radiology's waiting room. One or more suitable readers 18 may be positioned throughout the health facility in communication with server computer 4 to facilitate detection/reading of tags on objects at landmark locations of the health facility. Server computer 4 can then store the locations of tagged objects in computer storage 6 and use this stored location information to facilitate logistics planning in the manner described herein.

Active Logistics Measurement:

Logistical state may also be determined by server computer 4 through the collection of logistics information at landmark points in the treatment process, such as sign-in desks, triage areas, and treatment spaces, using various patient identifying methods. These methods may include card swipes, the use of biometric data, such as fingerprint scans, or other similar modes where the logistics information can be acquired by one or more suitable electronic data entry means or active measurement device 20, such as, without limitation, a card reader, a biometric scanner, a keyboard, a computer mouse, etc. and provided to server computer 4. Patient information may be provided to server computer 4 at points in the treatment process where patient identifying information is already required to advance to the next stage of care (e.g. signing in to a treatment area), but collecting that same information in an electronic format, e.g., via data entry means 20, and in a manner that takes less nursing time than current methods.

Server computer 4 may also collect additional logistics information from clinical care workers at any point in the process via a handheld device 2 (or other appropriate device or platform) that provides an interface between that worker and the robotic management system. The description and use of handheld device 2 herein is not to be construed as limiting the invention since it is envisioned that any other suitable and/or desirable wired or wireless device or platform that facilitates bidirectional communication with server computer 4 may also be used. By patterning the visual interface displayed on the visual display 14 each handheld device 2 after queries that caregivers normally make of nursing staff managers (supervisors), information can be elicited about the caregiver's status, the status of the caregiver's patient(s), the status of patient diagnostics, and other similar logistics information without creating an additional burden on the caregiver.

Resource State Indicators:

In certain cases, such as monitoring for completion of a patient's lab results, it may be more efficient to directly monitor the state of this resource (the lab) through a direct interface to the laboratory device 16, e.g., a stationary computer disposed in the laboratory or a handheld device 2 belonging to a laboratory personnel. Server computer 4 may therefore collect logistics information directly from clinical care resources by monitoring their existing healthcare IT resources, where possible. The objective would not necessarily be to collect, transport, or display the patient information itself, but rather to note (i) its state (e.g. that the sample arrived at the lab; that it is fifth in the queue; that it is in process; or that results are now available) and/or (ii) maintain a pointer to the data's location such that it can be easily queried by a caregiver through their distributed computing device or other device.

Data Fusion of Logistical State:

The state of an individual object, such as a patient, a caregiver, or a resource can be estimated by server computer 4 by fusing the data of several different measurements, each of which provides some evidence of that objects state. For example, the logistical state of a patient may be determined by server computer 4 by noting that the patient is in the waiting room of radiology, that the MRI completed a scan 10 minutes ago, and that the radiology nurse has entered information into a database related to the patient's scan. No radiology report on the patient is found in the database. Each of these measurements provides some evidence that the patient has probably completed their scan, but that the radiologist has not read it yet. Server computer 4 can deduce that the patient is headed to the next location on their itinerary.

Queue Observation, Simulation & Prediction:

The logistical state of patients, caregivers, and resources will also be estimated by server computer 4, in part, through simulation of the queues. Simulation is especially beneficial for those portions of the logistic state that cannot be directly measured, but for which a model can be built. Techniques of observation, as from modern control theory, may also be used to construct portions of the state vector that are not directly measured, but that may be observed through measurements of other related variables, as is commonly performed in state estimation theory.

Amenability of Healthcare Logistics to Simulation:

The progression of patient treatments is well understood for large portions of the patient treatment processes and therefore, by extension, the progression of a single patient through the treatment of a medical condition is generally fairly well understood at the logistical level. The patient will present to the healthcare facility through one of only a few means (emergency department, physician admit, etc.) and progress to a first treatment unit, where they will stay until their condition changes sufficiently to warrant movement to another unit, either step-up or step-down, or until all items on a patient treatment checklist are complete or the patient's diagnosis changes.

Reasonable estimates of both the length of patient stay as well as the portion of the stay expected to be spent in each treatment unit can be generated based on historical information and stored in computer storage 6 for access by server computer 4; additionally, with the implementation of the logistics measurements by server computer 4 described above, the length of stay on a unit-by-unit basis can be learned by server computer 4 across very large patient populations, together with accurate assessments of the uncertainty (e.g. statistical standard deviation) of those stays. Such information provides a powerful basis for server computer 4 to predict and plan future treatment logistics needs for the patient population through the use of simulators.

Dealing with Uncertainty in Treatment Logistics:

For certain treatments, such as labor and delivery or an orthopedic outpatient surgery (e.g. knee or hip-replacement) the uncertainty in treatment logistics is relatively low. Complications from these conditions have relatively low rates of occurrence, thus patient length of stay is more certain, leading to more accurate predictions that can be stored in computer storage 6 for access by server computer 4. For other treatments, such as trauma surgery, the uncertainty is much higher. Complications from these conditions can be more varied and more significant, making the accuracy of the prediction of the patient's treatment logistics much less certain.

Uncertainty can be contained within known statistical limits, thereby enabling simulations run by server computer 4 to produce an envelope of statistically probable outcomes for each patient. These envelopes have two benefits to predicting logistics needs. First, they will generally tend to establish minimum probable times that patients will likely spend in a unit—as one example, a cardiac patient recently admitted to a cardiac care unit will likely spend a minimum of several hours undergoing observation and testing, thereby creating a very low likelihood of, e.g. discharge.

Second, the fusion of a large population of patients logistics needs will provide an envelope of probable near-term demand for various clinical services, which can be checked against each unit's capacity for providing such services during that time frame. There is a great opportunity to eliminate, e.g., bed shortages by knowing that there is a 50% chance that a certain unit will run out of open beds within the next six hours. Discharges from that unit can be prioritized and communicated by server computer 4 to the handheld devices 2 carried by appropriate personnel to prevent such an occurrence. Staffing may also be preferentially allocated by server computer 4 to that unit in order to manage the expected increase in patient flow.

Simulating Patient Logistical Needs:

One CLM function implemented by server computer 4 is to simulate: (i) future patient logistical status, and (ii) future logistical needs. Server computer 4 performs simulations of the future logistical state of the healthcare system based on certain assumed present rates and operational efficiencies—both of which are at least partially informed by a combination of (i) historical data and (ii) current or recent data—e.g. conditions over the last, e.g. hour, two hours, of some other time frame of interest.

Server computer 4 simulating a series of inter-dependent service queues implies the capacity for server computer 4 to predict logistics states across the system or any sub-portion thereof. The capacity for server computer 4 to predict further implies the capacity for simulating future events based on changes in a variety of inputs and/or system parameters. Server computer 4 can use these capabilities as part of an optimization framework considered below.

Learning:

Learning Technologies:

The accuracy of the various CLM functions implemented by server computer 4 may be improved by the application of learning technologies. The term “learning” here means, without limitation, any technologies that employ any type of data from a system to improve upon its performance at a given task, and/or to improve its internal representation of the problem at hand. Such data may come from different sources, such as historical logs or paper charts, financial information, existing IT systems, pre-recorded information from cameras or other sensors, or real-time data from such sensors as well. As such, learning may also be performed in different ways, depending on the type and quality of data available. For instance, supervised learning algorithms may be employed when both inputs and desired outputs are observed;

otherwise semi-supervised or unsupervised learning algorithms may be required. Learning systems may also take advantage of human experts via the use of online, or reinforcement learning techniques. Learning in this context may be performed at any time scale: from historical data observing trends over years to real-time feeds from sensors measuring a signal over a fraction of a second. Server computer 4 may implement one or more learning algorithms or the data obtained from the application of one or more learning algorithms may be provided to server computer 4 from another, remote source.

Amenability to Learning:

Learning algorithms may be employed, either by server computer 4 or by another computer, to learn a model of a highly complex process which might be impossible to build manually. For example, a healthcare facility may possess tens of units interacting in very complex ways. A learning system may be able to automatically build an accurate model of the process based on observations made at several locations within the facility. This learned model can in turn be used by server computer 4 to predict the response of such a facility to various inputs.

Labor and patient scheduling are tasks which could also be optimized by server computer 4 through learning imported to or determined by server computer 4. For example, a scheduling system (computer) may learn the mapping between inputs (number of patients, acuity, season, etc.), and the number of nurses needed to take care of these patients at any given time, and provide this learning to server computer 4.

Learning algorithms may also be employed by server computer 4 or handheld devices 2 to develop more intuitive human-computer interfaces. For instance, a handheld devices 2 could learn about the habits of its user by analyzing the trends in her input commands as a function of various factors (e.g. time, user role, etc.).

Dynamic Labor Scheduling:

Effective care logistics management requires ensuring that the right mix of caregivers is assigned by server computer 4 to each unit on a schedule that provides adequate coverage for the patient census. This problem is exacerbated by uncertainties in patient census and patient acuity, which can be addressed through automated predictive scheduling augmented by machine learning techniques.

Healthcare facilities must staff on various timescales and under various conditions of patient census uncertainty. Certain outpatient facilities or those facilities that perform highly predictable procedures with low risk of complications can schedule caregiver staff without difficulty, as staffing needs are predictable and relatively immune to change. Other facilities (e.g. general hospitals with trauma units) have highly changeable patient census and thus must staff on multiple timescales in order to accommodate patient needs.

Staffmg Timescales:

Caregiver managers must first staff against a nominal schedule (usually weekly, biweekly, or monthly). This is the normal staffing schedule which must accommodate individual caregivers' needs for vacation time, paid time off, and so forth, without compromising the needed “mix” of clinical attributes such as skill, experience, etc.

Many healthcare facilities use multiple nursing pools to fill their nominal staff schedule, including in-house nursing staff, agency nurses, traveling nurses, and so forth. These nursing pools each come with different sets of rules for call-offs and other schedule changes. Thus the makeup of staffing schedules creates a set of fmancial and operational challenges that must be addressed when changes in patient census dictate schedule changes. This same scenario may also apply with other types of caregivers, without loss of generality.

Healthcare facilities must regularly compare changes in patient census to caregiver staffmg levels in order to ensure proper coverage. Those facilities with significant census fluctuation generally employ a flex staff method, with an internal pool of caregivers that can be shifted to those units experiencing staff shortages. Note that staff shortages can be caused by either caregiver call-offs, increased patient census, or both. Care must be taken to properly match skill and experience between flex labor and the units requiring additional coverage, especially in certain departments like critical care, surgery, or labor and delivery that require highly specialized skills. When patient census drops significantly, caregivers may be called-off by the healthcare facility, which often requires adherence to a complex set of call-off rules between that facility and labor unions, agency contractors, traveling nurse contracts, and so forth.

Leading Indicators of Patient Present Rates:

Census prediction is critical to accurate caregiver staff scheduling. As noted before, census prediction may be very accurate in those units with little census variation, such as orthopedic surgical units, where almost all patients are pre-scheduled for procedures. Staff scheduling may be very inaccurate in hospitals with highly variable patient census such as trauma units.

For those units with high variability there is often significant predictive information available. For example, demand for both emergency department and medical/surgical units is partially driven by the rate of infectious disease progression. Emergency department s know that during flu season they will require additional nursing staff, but there is great uncertainty as to when flu season will start, how quickly it will ramp, and how many patients will become sick on a daily or weekly basis. Yet, in the U.S. the Centers for Disease Control regularly models outbreaks of influenza, which information could be fed into server computer 4 which in-turn can determine from said information the need to ramp-up staff at the earliest onset of new influenza outbreaks.

As another example, hospitals see significant increases in patient presentation rates during bad weather—snow, ice, and extreme heat events bring patients to the Emergency Department, with increased admissions to trauma, medical/surgical units. Here, server computer 4 can use weather forecasts together with historical admission rates accessible to server computer 4, e.g., from computer storage 6, to predict ranges of likely patient census for these units and adjust staffmg accordingly.

As a further example, many physicians have patient population information for patients who are more likely to seek treatment in the near-term for chronic conditions, follow-ups from recent acute conditions, and other medical indicators of future needs. As one example, most obstetrician/gynecological practices maintain a database of their pregnant patients' due dates. The simple accumulation of this information at server computer 4 can be used by server computer 4 to notify hospitals of the population who might present in labor and adjust staffing accordingly.

Hospital scheduling can significantly benefit from the inclusion of leading indicators of patient demand, especially information that reasonably predicts the type of medical treatment (e.g. infectious disease, trauma, or labor & delivery) that will be needed. Such information can be used by server computer 4 to create a probabilistic mapping of likely patient volumes, medical condition mixes, and nursing staff needs. Moreover, the application of learning technologies can enable such mappings to be created by server computer 4 and iteratively improved for local populations, ensuring best fits on a facility by facility basis.

Predicting Patient Flow:

Once patients have presented to the healthcare facility, having server computer 4 predict their logistical movement through the facility provides yet another input to predict required staffing schedules. We here wish to broaden the notion of staffmg schedules to include the possibility that caregivers may change their clinical function in response to changes in patient needs throughout their shift. This capacity might be used, as one example, in an outpatient treatment center where patients generally progress through 3 stages of treatment. Nurses performing the first stage of treatment may see the demand for their services decline part-way through the day, while demand for the second and third stages of treatment is picking up, as the patient moves through the stages of treatment.

The methods for predicting and scheduling patient logistics as patients progress through treatment discussed above can be generalized to include a simulation by server computer 4 in which the number of caregivers throughout the system may be increased, decreased, assigned a different function (e.g. holding the total labor pool the same), or any combination thereof, in order to determine the likely impact of such scheduling changes to patient flow.

This capability provides a new input to labor scheduling by server computer 4 as it both (i) provides a new measurement or estimate of demand as a schedule input; it (ii) enables candidate schedules to be simulated to determine the likely performance of the healthcare facility; and (iii) generalizes the concept of labor scheduling from shifts and workers to supply and demand.

Operational Impact of Census Changes:

The capability of server computer 4 to both predict and react to changes (either actual or probable) in patient census and/or acuity mix is critical to driving the operational efficiency of hospital units. In general, the best way to keep from falling behind is to not fall behind in the first place—thus, having server computer 4 predict or quickly react to census dynamics keeps a challenging situation in one hospital unit from spreading to other, linked units throughout the hospital.

These capabilities may be leveraged as a CLM function implemented by server computer 4 which automates (i) the creation of the schedule, (ii) suggestions to supervisors as to when labor schedule/assignment changes should be made, and (iii) a framework for executing labor schedule or labor assignment changes in real-time to a distributed group of caregivers.

For example, if a reasonable estimate indicates that influenza cases are likely to arise during the next 2 weeks, then server computer 4 can take the following steps: (i) increase the nominal schedule for emergency department nurses, (ii) ensure adequate emergency department-qualified nurses in the on-call flex staff nursing pool, (iii) prioritize transfers of patients out of the emergency department and into other hospital units upon admission in order to clear emergency department beds for additional patients. As patients actually present, the server computer 4 can then track their flow through stages of treatment and adjust labor schedules to meet the changing demand levels at different points in the system.

Moreover, actual presentation rates can be compared by server computer 4 to predicted rates through learning technologies to improve the accuracy of the simulator. Server computer 2 benefits from the inclusion of rigorous, statistical predictors integrated with appropriate machine learning tools to (i) develop increasingly accurate predictions; (ii) link those predictions to proposed staffing changes; and (iii) monitor the efficacy of the staff changes to actual patient progression through care in terms of patient wait times, nurse queue loads, and other operational and/or fmancial metrics.

Dynamic Patient Scheduling:

A new methodology implemented by server computer 4 for generating patient schedules at any general healthcare facility overcomes the lack of domain knowledge in schedule generation and an inability to update the schedule as conditions change.

The core function of healthcare logistics is to schedule patient care. Historically, a schedule is thought of as a fixed itinerary of activities to which one or more people adhere. A travel schedule might be comprised of a list of times at which the traveler will board a series of flights, trains, or cabs in order to reach a final destination with the understanding that (notwithstanding delays due to weather or equipment problems) the transports times are relatively fixed. The concept of patient scheduling in a hospital is quite different from the normal understanding of a schedule. As will be seen next, there are several classes of events that normally and regularly change a patient's schedule.

Patient Re-Prioritization:

Patients present into waiting areas where they sign-in or register. Patients may or may not have a scheduled time for their procedure, physician's visit, therapy, or other treatment. In units where acute patients may present (e.g. an Emergency Room, or the radiology department of a general hospital) and require immediate care, non-acute patients will be bumped to accommodate. Once acute patients are seen, non-acute patients are then taken in the order of their original appointments or, in the absence of absolute appointment times, on a first-come, first-serve basis. Thus, a patient presenting with a 1:15PM appointment time may be delayed by the presentation of acute patients requiring priority care.

Variation in Treatment Times:

The time required to provide a standard treatment may vary significantly from patient to patient. For example, the time required to provide a 40-year old ambulatory patient with a standard CAT scan will likely be much less than the time required to provide a frail 80-year old wheelchair bound patient with the same standard CAT scan. The 40 year old will likely hop up onto the table, assist the technician by lying in place quickly or changing positions as needed at different points in the scan. By contrast, in this example, the 80 year old will require significant assistance from the technician to get out of the wheelchair and onto the table. The technician may have to stay in the room in order to help the patient move into position or return to the room to adjust or change the patient's position as needed.

Variations in treatment time are not taken into account during historical patient scheduling. Thus, CAT scans for the 40 year old patient and the 80 year old patient in this example would be allocated the same amount of time. In all likelihood, the 80 year old would require more time than allocated for his CAT scan, thus creating a delay for all subsequent patients. In general, healthcare personnel who perform scheduling functions typically do not have domain expertise in the treatments for which they are scheduling. Thus, there is typically no way for them to make judgment calls that, for example, the frail 80-year old will require an additional 10-15 minutes for a CAT scan.

Unscheduled Patients:

Patient schedules generally do not provide for what might be called “probable-unknowns.” There is considerable uncertainty associated with patient census in almost every healthcare unit—standardized elective surgeries such as hip-replacement provide the counter-example. Patients may be scheduled weeks in advance for a three-day in-patient surgery. Complication rates are relatively low, thus there is very little variation in actual patient census for specialty orthopedic units handling these and similar surgeries. They are of course exceptions to the rule.

Most units, such as radiology, labs, medical/surgical units, ICU's, maternity, and so forth have significant variations from scheduled patient visits. Walk-in patients (e.g. a patient that walks in to a radiology unit in need of an X-ray of a recent elbow injury) and add-on patients (e.g. a scheduled patient whose physician requests tests or procedures in addition to those already scheduled) tend to present in these units every day; however, schedulers do not tend to employ historical data to provide for “probable-patients” who are likely to show up and impact the schedule.

Unintentional Overbooking:

In busy clinical settings, schedules are often completely booked for several hours. Staff schedulers will place patients in every open slot in their unit's schedule until all slots are filled. Once fully booked, unscheduled patients presenting in these time frames impact patient wait times. Nursing staff tend to compassionately attempt to “squeeze in” unscheduled patients, thus creating increased wait times for patients who follow. This problem is further exacerbated if the original schedule includes one or more patients who will require more than their scheduled time due to, for example, mobility problems as in the above example of the 80-year old patient requiring a CAT scan.

Static Patient Schedules:

Once patient schedules are developed for the day, they are generally static, meaning that they are not updated as reality deviates from the ideal. Ideally, patient schedules would be updated throughout the day in response to changing conditions to continually provide a best estimate of upcoming patient activities. This is precisely what nurse managers currently do in the face of highly fluid events—they construct their own event horizon of next tasks where the original patient schedule becomes but one input.

The inability to update patient schedules is one of the seminal problems with the “Unknown Wait.” Patients and their families enter a healthcare facility with an expectation formed by their initial schedule. As unfolding events (including patient re-prioritization, variation in treatment times, presentation of unscheduled patients, and overbooking) significantly change the schedule, patients have no way to update their expectations and, moreover, overworked nurses have very little time to communicate with waiting patients and no real basis for giving them a new estimate of when they will be seen.

No-Shows:

Patient schedules are impacted by both physician and patient no-shows. Physician (or other caregiver) no-shows create further pressure on the schedule, while patient no-shows present an opportunity (but not a guarantee) of relieving that pressure. Physicians may not show up on time for an appointment as they may be, for example, called away to deal with an emergency, detained in surgery, or even more mundanely, be stuck in traffic. Physician no-shows are particularly problematic because they remove resource from the system, thus the continuum of patients and procedures associated with that physician will be delayed and/or need to be rescheduled.

Patient no-shows create a unique, but generally untapped opportunity within the schedule. A no-show reduces demand on the schedule, which may be put to good use if another patient can be serviced in that slot, or if that time can be used to reduce delays associated with other patient who may now be taken sooner.

Non-Opportunistic Schedules:

Patient scheduling is non-opportunistic, meaning that there is no agent that searches out opportunities to improve the schedule as events unfold throughout the day. Opportunities can arise either because time becomes available (e.g. a patient no-show or because procedures take less time than originally scheduled) or because patient flow can be improved by re-sequencing one or more patients' schedules (e.g. a patient who is scheduled for blood work, a doctor's visit, and then a pre-admission X-ray could leave the facility sooner if they are able to use a suddenly open slot in radiology prior to their doctor's visit).

Certain Demand:

Patient schedules are generated based upon a request from a clinical care worker (physician, nurse, etc.) based upon a physician's decision. These decisions range from decisions to have blood tests performed, to decisions to admit the patient and/or schedule surgery. Each such decision impacts resources throughout the clinical setting, for example, the decision to admit a patient will require that a bed in another unit be prepared and a nurse scheduled to perform the admission.

On a single-patient basis, scheduling based on certain demand (certain here meaning non-probabilistic) make sense. A patient either will or will not be admitted. However, for a large population of patients, e.g. for 20 patients in the Emergency Room, there is a group probability that N patients will be admitted and, moreover, each patient has an individual probability of requiring admission to a certain unit—e.g. cardiac patients have a high probability of being admitted to an ICU, CCU, or similar unit.

Schedules based upon certain-demand suffer from the inability to provide next-stage resources with the opportunity to prepare for a new patient intake event, new patient treatment, etc. An ICU would benefit, for example, from knowing the number of probable admissions across every potential input unit that they serve. If, for example, a Medical/Surgical unit knew that there were two patients in ER each with a 50% probability of needing Medical/Surgical services and another 4 patients in other units throughout the hospital with conditions that were 25% likely to require stepping them up to a Medical/Surgical unit, then they might deem it wise to begin now to prepare 2-4 beds for likely admits. Without such probabilistic information, the Medical/Surgical unit will not have advance warning, but rather will learn that there are 3 admits when those admits are actually deemed certain—requiring patients to wait until the unit is prepared to take them.

Limitations of Current Approaches:

Patient scheduling currently suffers from the general inability of schedulers to properly predict how patients will actually progress through stages of treatment. Earlier sections disclosed how server computer 4 can be used for predicting how patients might progress through care, based on simulation of the logistics of the healthcare system as trained or calibrated using prior knowledge of patient logistical outcomes. Clearly, human schedulers lack such means of predicting the flow of a single patient through a facility. The complexities of simulating dozens or hundreds of patients simultaneously and then determining how best to schedule the next patient is generally beyond the capabilities of human scheduling assistants.

Patient Schedule Creation through Simulation:

Queue simulation software, which was previously described for use in making predictions of future patient needs, may also be used by server computer 4 to determine the optimal time to schedule a future patient. Using the same queue structure and simulation methods, server computer 4 can have the queue simulation software consider starting a patient at a variety of days and times and determine the optimal time to initially present to the healthcare facility in order to, for example, progress through treatment in the shortest possible time.

The queue simulation software can simultaneously account for sources of non-patient schedule impact previously disclosed, including but not limited to: (i) likely additional patients; (ii) likely add-on procedures; (iii) likely or potential no-shows; and (iv) variations in treatment times. These factors, and others like them, may be included in the schedule simulation in order to avoid the creation of an unintentionally overbooked schedule, e.g. a schedule which exceeds or likely will exceed the capacity of the Unit if a sufficient number of the “probable” events actually occur. Such a schedule contains what might be termed “headroom” in the sense that the healthcare system is not permitted to be scheduled for demand which, when added to unscheduled demand that ultimately appears, is beyond the supply capacity of the system.

Dynamically Updating the Patient Schedule:

The patient schedule can be dynamically updated by server computer 4 at any time, including before the patient actually presents at the healthcare facility. The ability to update the schedule, based for example on one of the “probable” events, such as a physician no-show actually occurring, enables the maintenance of a current best estimate of the patient schedule.

Dynamic updates may also be enabled by the introduction of new capacity into server computer 4. For example, should patient no-shows occur, this information can be entered into server computer 4, e.g., via a handheld device 2, which responds by creating/seeking opportunities to either shift patients forward in time or recover from previous demand overages. Dynamic updating by server computer 4 in this sense can leverage the communication capabilities of server computer 4 and handheld devices 2 to reach out and contact patients or patient coordinators who can then find patients to fill in these new capacity opportunities.

Informing the Patient:

Dynamic updates primarily benefit the patient by enabling him or her to adjust his or her “real-world” schedule, inform friends or family of changes in, e.g. pick-up times, or otherwise align the patient's loved ones with the new best estimate of the healthcare facility's treatment schedule. Patients or their family may be linked to server computer 4 through, e.g. a cell phone interface, that enables them to receive from server computer 4 periodic, alert-based, or other types of schedule updates. Such interfaces may also be used to information server computer 4 of changes to the patient's schedule that may impact the healthcare facility, e.g. that the patient is canceling, will be 30 minutes late, 20 minutes early, or has other issues that impact their schedule.

As can be seen, the present invention provides a number of technical advantages, including, without limitation: connections based on roles of caregivers and not on persons or fixed handheld devices addresses; and informing a caregiver having a role for a patient as soon as some data related to treatment and/or processing of the patient, e.g., examination results, treatment or processing complete, etc., becomes available. To this end, and according to the invention, a connection is made to a handheld device assigned to a role, wherein the handheld device associated with said role varies in time. This enables a caregiver to connect to directly to a caregiver actually performing said role.

This technical problem is overcome by the use of server computer 4 hosting a database that can be stored in computer storage 6, which database includes links between handheld devices, the user's assigned or associated with certain handheld devices, and the roles and schedules of said users. The use of other links may also be desirable and are envisioned.

Data regarding such links may be input into this database via a suitable human machine interface of server computer 4, via one or more handheld devices 2, or some combination thereof. Data regarding roles of caregivers can be retrieved from the database and used by server computer 4 to cause one or more handheld devices 2 to contact the handheld device 2 of the user fulfilling a specific role, e.g., the supervising nurse presently on duty. The database can be updated as necessary by server computer 4 on the basis of, among other things: caregivers work schedules available to server computer 4, wherein server computer 4 changes in the database, based on the time and date a user is scheduled to fulfill a specific role, the handheld device (of the user scheduled to fulfill the role) to contact in response to request by another handheld device to be connected to the role presently fulfilled by said user, e.g., the nurse supervisor presently on-duty; and/or the clocking-in (or logging in) for work of the caregiver having a specific role, e.g., the nurse supervisor, which clocking-in is available to server computer 4 which changes in the database the handheld device to contact in response to request by another handheld device to be connected to the role presently fulfilled by said user.

The invention has been described with reference to exemplary embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of controlling patient care logistics comprising:
(a) providing a programmed computer;
(b) providing a plurality of user devices in operative communication with the computer;
(c) causing the computer to determine for each user device a unique priority sorted list of queue tasks for the user of said user device, wherein each unique priority sorted list of queue tasks is determined on the basis of criterion that affect the determination of the priority sorted lists of queue tasks for the plurality of user devices;
(d) dispatching to each user device the unique priority sorted list of queue tasks determined for said user device in step (c);
(e) the computer receiving a change in at least one criterion;
(f) causing the computer to determine for each user device on the basis of the change received in step (e) either an amendment to the unique priority sorted list of queue tasks for the user of said user device determined in step (c) or a new unique priority sorted list of queue tasks for the user of said user device; and
(g) dispatching to each user device the unique priority sorted list of queue tasks determined for said user device in step (f).

2. The method of claim 1, further including repeating steps (e)-(g).

3. The method of claim 1, further including the computer responsive to user activation of a first one of the user devices for causing said first user device to be coupled in communication with a second one of the user devices.

4. The method of claim 3, wherein the first and second user devices are coupled in wireless communication with each other.

5. The method of claim 3, wherein the computer determines the second user device to connect in communication with the first user device based on a role of a user of the second user device.

6. The method of claim 1, wherein the change in the at least one criterion includes a change in at least one of the following: physician's order, patient diagnosis, patient treatment plan, patient wait time, staffing level; care load; patient census; patient acuity; patient flow; patient present rate; bed availability; task assignment; task completion; caregiver skills; patient priority needs; a location of an object; time of day; day of the week; local weather; disease progression; and an emergency condition.

7. The method of claim 1, wherein the change in the at least one criterion originates at one of the following: one of the user devices; a passive measurement device; an active measurement device; or another computer.

8. A patient care logistics control system comprising:
a logistics software program;
a server computer operating under the control of the logistics software program for sequentially determining plural sets of priority sorted lists of queue tasks, wherein each set of priority sorted lists of queue tasks is determined in response to a change in at least one criterion used for determining the priority sorted lists of queue tasks;
a plurality of intelligent wireless user devices, each user device including a visual display; and
a wireless network connecting the server computer and the user devices and operative for wirelessly delivering for display on the display of each user device for each set of priority sorted lists of queue tasks a unique one of the priority sorted list of queue tasks on the basis of the user assigned to the user device or a role of a user assigned to the user device.

9. The patient care logistics control system of claim 8, wherein the wireless network comprises radio transceivers associated with the user devices and the server computer.

10. The patient care logistics control system of claim 8, wherein the server computer causes the wireless network to couple two user devices in communication.

11. The patient care logistics control system of claim 8, wherein the change in at least one criterion originates at one of the following: at the server computer; one of the user devices; a passive measurement device; an active measurement device; or another computer.

12. The patient care logistics control system of claim 8, wherein the criterion used for determining the priority sorted lists of queue tasks includes at least one of the following: staffmg level; caregiver patient load; patient census; patient acuity; patient flow; patient present rate; bed availability; caregiver task assignment; caregiver task completion; caregiver skills; patient priority needs; a location of an object; time of day; day of week; local weather; disease progression; or an emergency condition.

13. The patient care logistics control system of claim 8, wherein each priority sorted list of queue tasks is wirelessly delivered to its user device in real-time.

14. The patient care logistics control system of claim 8, wherein the plural sets of priority sorted lists of queue tasks is determined based on plural service queue models included in the logistics software program, wherein each service queue model includes tasks to be performed by a caregiver on or for the benefit of at least one patient.

15. The patient care logistics control system of claim 8, wherein two priority sorted lists of queue tasks delivered to one user device includes a change in a priority of at least one task.

16. A method of controlling patient care logistics comprising:
(a) providing a programmed computer;
(b) providing a plurality of user devices in operative communication with the computer;
(c) modeling on the programmed computer patient care as a multitude of queue tasks to be performed by a plurality of users, wherein each user has an associated role and carries a user device;
(d) receiving modeling criterion via one of the following: one of the user devices; a passive measurement device; an active measurement device; or another computer;
(e) causing the computer to run logistics management software to determine for each user device a unique priority sorted list of queue tasks for the user of said user device based on the patient care model, wherein each unique priority sorted list of queue tasks is determined on the basis of the modeling criterion;
(f) dispatching to each user device the unique priority sorted list of queue tasks determined for said user device in step (e);
(g) the computer receiving a change in at least one criterion;
(h) causing the computer to run the logistics management software to determine for each user device on the basis of the change received in step (g) either an amendment to the unique priority sorted list of queue tasks for the user of said user device determined in step (e) or a new unique priority sorted list of queue tasks for the user of said user device; and
(i) dispatching to each user device the unique priority sorted list of queue tasks determined for said user device in step (h).

17. The method of claim 16, further including the computer responsive to user activation of a first user device for causing said first user device to be coupled in communication with a second user device.

18. The method of claim 17, wherein the first and second user devices are coupled in wireless communication with each other.

19. The method of claim 17, further comprising:
(j) assigning the role of a user to the user device of said user; wherein the computer determines the second user device to connect in communication with the first user device based on the role of a user of the second user device.

20. The method of claim 16, wherein the change in the at least one criterion includes a change in at least one of the following: physician's order, patient diagnosis, patient treatment plan, patient wait time, staffing level; care load; patient census; patient acuity; patient flow;
patient present rate; bed availability; task assignment; task completion; caregiver skills; patient priority needs; a location of an object; time of day; day of the week; local weather; disease progression; and an emergency condition.

21. The method of claim 16, wherein the change in the at least one criterion originates at one of the following: one of the user devices; a passive measurement device; an active measurement device; or another computer.

22. The method of claim 19, further comprising:
(k) defining for a patient a set of roles based on the requested patient care;
(l) linking in a database the patient to one or more user devices on the basis of the set of roles;
(m) initiating an activity for said patient resulting in one or more queue tasks for one or more roles;
(n) causing the computer to run the logistics management software to determine for each user device on the basis of the one or more queue tasks generated in step (m) either an amendment to the unique priority sorted list of queue tasks for the user of said user device determined in step (e) or step (h) or a new unique priority sorted list of queue tasks for the user of said user device;
(o) receiving criterion indicating that examination results of said patient have been made available in the programmed computer;
(p) determining a first user device having a queue task associated with said examination results; and
(q) instructing the first user device determined in (p) to inform the user that the test results have been made available.

23. The method of claim 22, wherein the computer determines a second user device to connect in communication with the first user device based on a role of a user of the second user device.

24. A patient care logistics control system comprising:
a logistics software program;
a plurality of intelligent wireless user devices, each user device including a visual display;
a server computer configured to model patient care as a multitude of queue tasks to be performed by a plurality of users, wherein each user has an associated role and carries a user device, the server computer further configured for receiving criterion via one of the following:
one of the user devices; a passive measurement device; an active measurement device; or another computer, wherein the server computer is operating under the control of the logistics software program for sequentially determining plural sets of priority sorted lists of queue tasks for the user a user device based on the patient care model, wherein each set of priority sorted lists of queue tasks is determined on the basis of the criterion; and
a wireless network connecting the server computer and the user devices and operative for wirelessly delivering for display on the display of each user device for each set of priority sorted lists of queue tasks a unique one of the priority sorted list of queue tasks on the basis of the user assigned to the user device or a role of a user assigned to the user device.

25. The patient care logistics control system of claim 24, wherein the server computer is configured to assign a role of a user to the user device of said user and to causes the wireless network to couple two user devices in communication based on the roles of at least one said user associated with said user devices.

26. The patient care logistics control system of claim 24, wherein the change in at least one criterion originates at one of the following: at the server computer; one of the user devices; a passive measurement device; an active measurement device; or another computer.

27. The patient care logistics control system of claim 24, wherein the criterion used for determining the priority sorted lists of queue tasks includes at least one of the following: physician's order, patient diagnosis, patient treatment plan, patient wait time, staffing level; care load; patient census; patient acuity; patient flow; patient present rate; bed availability; task assignment; task completion; caregiver skills; patient priority needs; a location of an object; time of day; day of the week; local weather; disease progression; and an emergency condition.

28. The patient care logistics control system of claim 24, wherein each priority sorted list of queue tasks is wirelessly delivered to its user device in real-time.

29. The patient care logistics control system of claim 24, wherein the plural sets of priority sorted lists of queue tasks is determined based on plural service queue models available to the logistics software program, wherein each service queue model represents tasks to be performed by a caregiver on or for the benefit of at least one patient.

30. The patient care logistics control system of claim 24, wherein two priority sorted lists of queue tasks delivered to one user device includes a change in a priority of at least one task.

31. The patient care logistics control system of claim 26, wherein the server computer comprises a processor, and memory with data, and instructions stored therein so that the computer can execute a predetermined program wherein the program is arranged to enable the processor:
to define for a patient a set of roles based on the requested patient care;
to link in a database the patient to one or more user devices on the basis of the set of roles;
to initiate an examination for said patient resulting in one or more queue tasks for one or more roles;
to cause the computer to run the logistics management software to determine for each user device on the basis of the one or more queue tasks generated either an amendment to the unique priority sorted list of queue tasks for the user of said user device or a new unique priority sorted list of queue tasks for the user of said user device;
to receive the criterion indicating that examination results of said patient have been made available in the programmed computer;
to determine a first user device having a queue task associated with said examination results; and,
to instruct the first user device determined to inform the user that the test results have been made available and wherein the first user device is configured to inform the user in response to the instruction generated by the server computer.

32. The patient care logistics control system of claim 31, wherein the program is further arranged to determine a second user device to connect in communication with the first user device based on a role of a user of the second user device accessible to the computer, and to transmit an identification information associated with the second user device to the first user device, wherein the first user device is configured to receive the identification information associated with the second user device and to connect with the second user device based on said identification information.
